(19) United States
(12) Patent Application Publication
(10) Pub. No.: US 2009/0259963 A1
(43) Pub. Date: Oct. 15, 2009

(54) Display Area Navigation

(75) Inventors: Abhijit Vyas, Singapore (SG); Teo Kok Keong, Singapore (SG)

Correspondence Address: HAYNES AND BOONE, LLP;IP Section, 2323 Victory Avenue, Suite 700, Dallas, TX, 75219, US

(73) Assignee: DELL PRODUCTS L.P., Round Rock, TX (US)

(21) Appl. No.: 12/103,016

(22) Filed: Apr. 15, 2008

(51) Int. Cl. G06F 3/048

(52) U.S. Cl. 715/783

(57) ABSTRACT

Display area navigation includes detecting an input device event, providing a display area navigation window, receiving a display area navigation command, and relocating an input pointer according to the display area navigation command. A display area provided by a large display and/or a plurality of displays may be quickly and easily navigated by using the display area navigation window to select a desired input pointer location on the display area.

### BACKGROUND

The present disclosure relates generally to information handling systems, and more particularly to the navigation of a display area on an information handling system.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

IHSs typically include one or more displays having a display area that may be used to display information in order to, for example, view, manipulate, and/or perform a variety of other actions on the information provided on the display area. As the costs of displays goes down, more and more IHS users are utilizing larger displays and/or multiple displays in order to display the information in their IHSs. As the total display area becomes larger, whether it be due to, for example, a very large display or a plurality of linked displays, the ability for the IHS user to easily and quickly navigate the display area with an input pointer such as, for example, an input pointer that is provided by a touch pad, mouse, and/or other input device, raises a number of issues.

Such large display areas increase the total distance that an input pointer must traverse in order to interact with, for example, applications running on the IHS that display information somewhere on the display area. In order to cause the input pointer to accomplish such a traverse, the IHS user may, for example, move their input device (e.g., a mouse or a finger on a track pad) up to an edge of its input device pad, pick up the input device, bring the input device back across the input device pad, set the input device back down on the input device pad, move the input device again to the edge of the input device pad, and repeat until the input pointer is at the desired location on the display area. This increases the time and effort required to navigate the display area, and can result in a significant loss of productivity for the IHS user that can be magnified when, for example, there is limited input pad space (e.g., a small desktop or table space), the input device is malfunctioning, or the display area includes a relatively long dimension relative to its other dimensions (e.g., when three widescreen displays are positioned side-by-side to produce the display area.)

Conventional solutions include systems that allow the input pointer to be transferred across multiple display configurations from a position on a first display to a predetermined position on a second display by hitting a key or button. Such solutions include transferring the input pointer from a position on the first display to a position at the center of the second display, transferring the input pointer from a position on the first display to a position on the second display that is the same relative position on the second display that it was on the first display, or transferring the input pointer from a position on the first display to a position on the second display that is the last known position of the input pointer on the second display. Such solutions offer only non-precise navigation of the display area that still require the user of the IHS to move the input pointer to the desired location on the display area once the input pointer has been transferred to the desired display.

Accordingly, it would be desirable to provide for improved display area navigation absent the disadvantages discussed above.

### SUMMARY

According to one embodiment, display area navigation includes detecting an input device event, providing a display area navigation window, receiving a display area navigation command, and relocate an input pointer according to the display area navigation command.

### BRIEF DESCRIPTION OF THE DRAWINGS

FIG. 1 is a schematic view illustrating an embodiment of an information handling system.

FIG. 2 is a perspective view illustrating an embodiment of an information handling system including two displays.

FIG. 3a is a flow chart illustrating an embodiment of a method for display area navigation.

FIG. 3b is a schematic view illustrating an embodiment of a display including a input device event area.

FIG. 3c is a front view illustrating a display area navigation window on one of the displays of FIG. 3a with an input pointer in a first input pointer location.

FIG. 3d is a front view illustrating a display area navigation window on one of the displays of FIG. 3a with the input pointer of FIG. 3c having been moved on the display area navigation window.

FIG. 3e is a graphical view illustrating a display area navigation window and a display area.

FIG. 3f is a perspective view illustrating an embodiment of the information handling system including the two displays of FIG. 2 with the input pointer relocated to a second input pointer location.

FIG. 4a is a front view illustrating a display area navigation window on one of the displays of FIG. 3a with an input pointer in a first input pointer location.

FIG. 4b is a front view illustrating a display area navigation window on one of the displays of FIG. 3a with the input pointer of FIG. 4a having been moved on the display area navigation window.

FIG. 4c is a perspective view illustrating an embodiment of the information handling system including the two displays of FIG. 2 with the input pointer relocated to a second input pointer location.

FIG. 5a is a perspective view illustrating an embodiment of an information handling system including four displays.

FIG. 5b is a front view illustrating a display area navigation window on one of the displays of FIG. 5a with an input pointer in a first input pointer location.

FIG. 5c is a front view illustrating a display area navigation window on one of the displays of FIG. 5a with the input pointer of FIG. 5b having been moved on the display area navigation window.

FIG. 5d is a perspective view illustrating an embodiment of the information handling system including the four displays of FIG. 5a with the input pointer relocated to a second input pointer location.

FIG. 6a is a perspective view illustrating an embodiment of an information handling system including three displays.

FIG. 6b is a front view illustrating a display area navigation window on one of the displays of FIG. 6a with an input pointer in a first input pointer location.

FIG. 6c is a front view illustrating a display area navigation window on one of the displays of FIG. 6a with the input pointer of FIG. 6b having been moved on the display area navigation window.

FIG. 6d is a perspective view illustrating an embodiment of the information handling system including the three displays of FIG. 6a with the input pointer relocated to a second input pointer location.

FIG. 7a is a perspective view illustrating an embodiment of an information handling system including a single display.

FIG. 7b is a front view illustrating a display area navigation window on one of the displays of FIG. 7a with an input pointer in a first input pointer location.

FIG. 7c is a front view illustrating a display area navigation window on one of the displays of FIG. 7a with the input pointer of FIG. 7b having been moved on the display area navigation window.

FIG. 7d is a perspective view illustrating an embodiment of the information handling system including the single display of FIG. 7a with the input pointer relocated to a second input pointer location.

### DETAILED DESCRIPTION

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a network server or storage device, a switch router or other network communication device, or any other suitable device and may vary in size, shape, performance, functionality, and price. The IHS may include memory, one or more processing resources such as a central processing unit (CPU) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

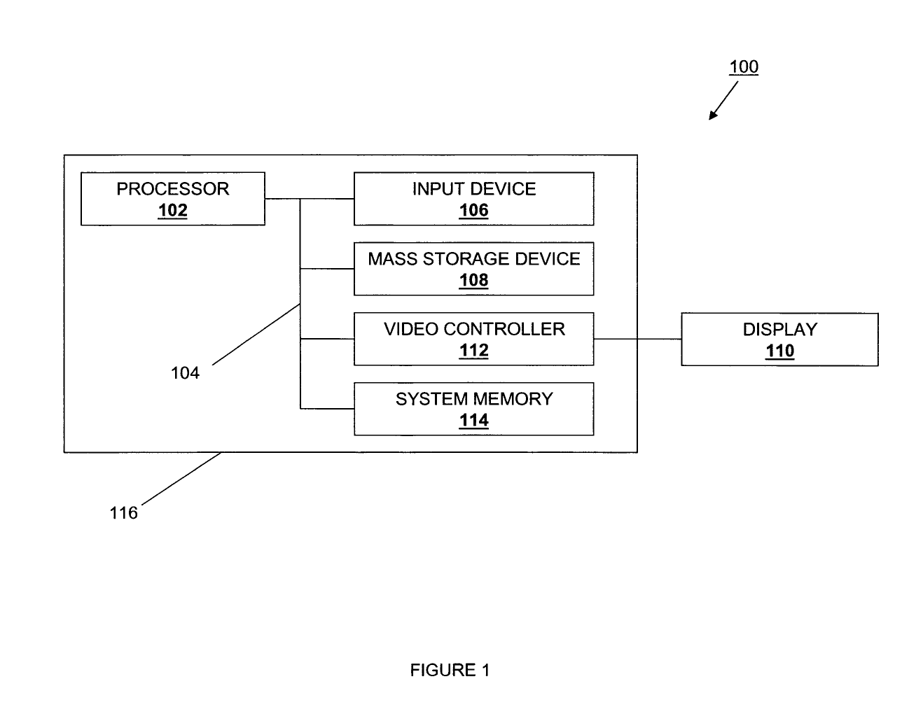

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102. While the display 110 is illustrated as located outside of the chassis 116, in an embodiment, some or all of the display 110 may be located within the chassis 116 such as, for example, when the display 110 includes a display screen that is included on a portable IHS (e.g., a laptop or notebook computer.)

In an embodiment, the IHS 100 includes a computer-readable medium that may be, for example, the mass storage device, the system memory, removable media, and/or a variety of other computer-readable mediums known in the art. The computer-readable medium and the processor 102 are structurally and functionally interrelated with one another as described below in further detail.

The computer-readable medium stores (e.g., encodes, records, or embodies) functional descriptive material (e.g., including but not limited to software (also referred to as computer programs or applications) or data structures). Such functional descriptive material imparts functionality when encoded on the computer-readable medium. Also, such functional descriptive material is structurally and functionally interrelated to the computer-readable medium.

With such functional descriptive material, data structures define structural and functional interrelationships between such data structures and the computer-readable medium (and other aspects of the IHS 100). Such interrelationships permit the data structures' functionality to be realized. Also, within such functional descriptive material, computer programs define structural and functional interrelationships between such computer programs and the computer-readable medium (and other aspects of the IHS 100). Such interrelationships permit the computer programs' functionality to be realized.

For example, the processor 102 may read (e.g., accesses or copies) such functional descriptive material from the computer-readable medium onto, for example, the system memory 114 of the IHS 100, and the IHS 100 (more particularly, the processor 102) performs its operations, as described elsewhere herein, in response to such material which is stored in the system memory 114 of the IHS 100. More particularly, the processor 102 performs the operation of processing a computer application (that is stored, encoded, recorded, or embodied on a computer-readable medium) for causing the processor 102 to perform additional operations, as described elsewhere herein. Accordingly, such functional descriptive material exhibits a functional interrelationship with the way in which processor 102 executes its processes and performs its operations.

Further, the computer-readable medium is an apparatus from which the computer application is accessible by the processor 102 for instructing the processor 102 to perform such additional operations. In addition to reading such functional descriptive material from the computer-readable medium, the processor 102 is capable of reading such functional descriptive material from (or through) a network which is also a computer-readable medium (or apparatus).

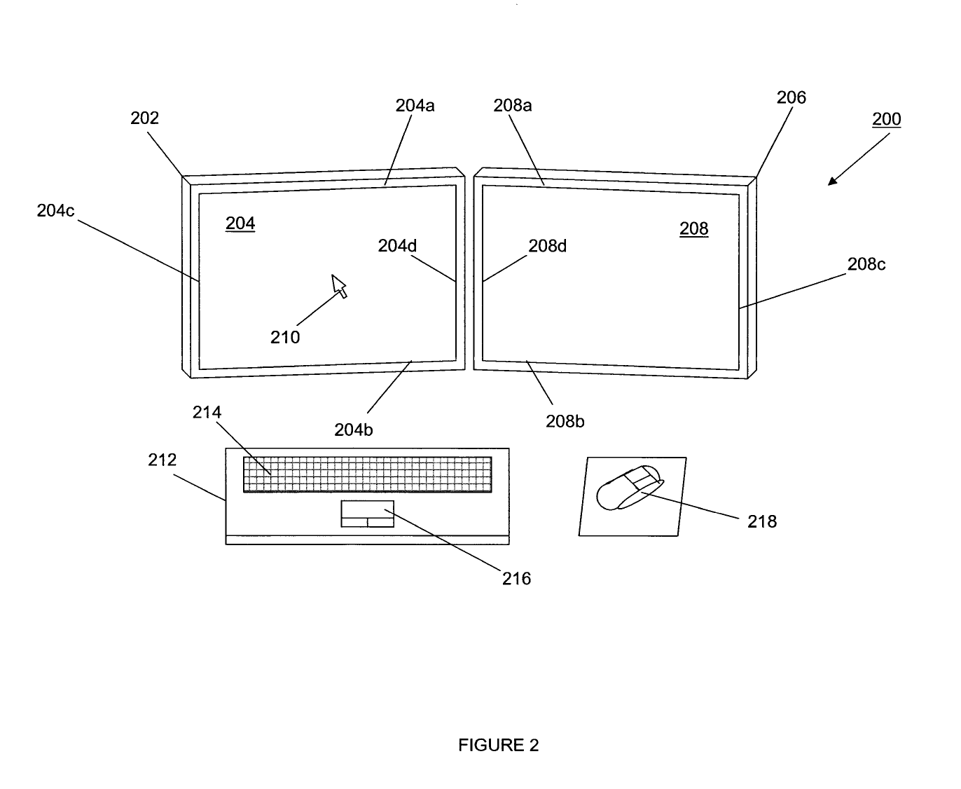

Referring now to FIGS. 1 and 2, an IHS 200 is illustrated. The IHS 200 includes a first display 202 having a first display screen 204 with a top edge 204a, a bottom edge 204b located opposite the top edge 204a, and a pair of opposing side edges 204c and 204d extending between the top edge 204a and the bottom edge 204b. In an embodiment, the first display 202 may be included in the display 110, described above with reference to FIG. 1. The IHS 200 also includes a second display 206 having a second display screen 208 with a top edge 208a, a bottom edge 208b located opposite the top edge 208a, and a pair of opposing side edges 208c and 208d extending between the top edge 208a and the bottom edge 208b. In an embodiment, the second display 206 may be included in the display 110, described above with reference to FIG. 1. In an embodiment, the video controller 112 is operable to provide information on the display screens 204 and 208 as if the displays screens 204 and 208 were a single display screen using methods known in the art. In an embodiment, the display screens 204 and 208 provide a display area. The IHS 200 also includes an input pointer 210 that is operable to be moved to any location on the display area provided by the display screens 204 and 208. The IHS 200 also includes a first input device 212 which may be, for example, a conventional keyboard, that includes a plurality of keys 214 and a track pad 216. In an embodiment, the first input device 212 may be, for example, the input device 106, described above with reference to FIG. 1, and may be coupled to the processor 102 wirelessly (as illustrated), with a cable, and/or using a variety of other methods known in the art. The IHS 200 also includes a second input device 218 which may be, for example, a conventional mouse. In an embodiment, the second input device 218 may be, for example, the input device 106, described above with reference to FIG. 1, and may be coupled to the processor 102 wirelessly (as illustrated), with a cable, and/or using a variety of other methods known in the art. While a pair of input devices have been illustrated, the present disclosure is not limited to such examples, and one of skill in the art will recognize the many different input devices that may be used without departing from the scope of the present disclosure.

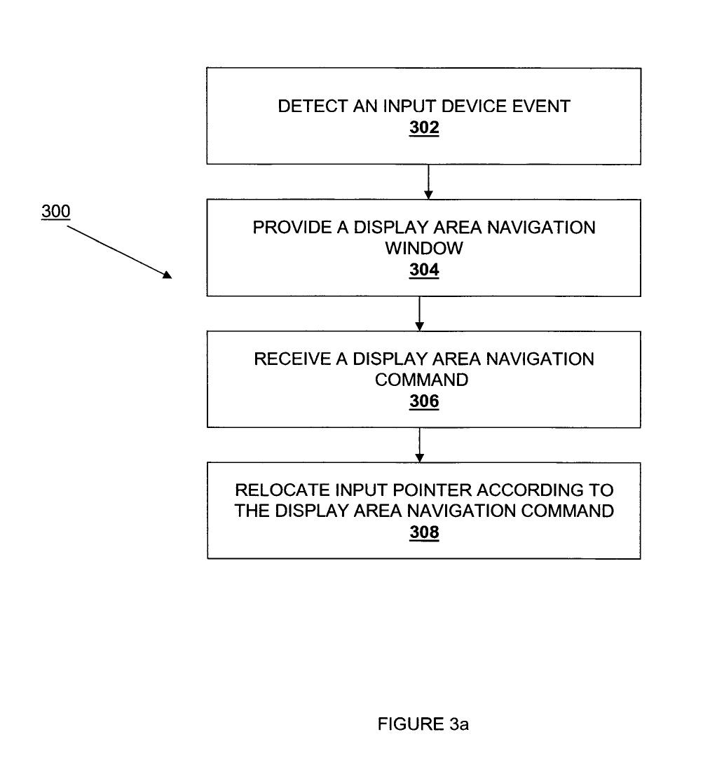

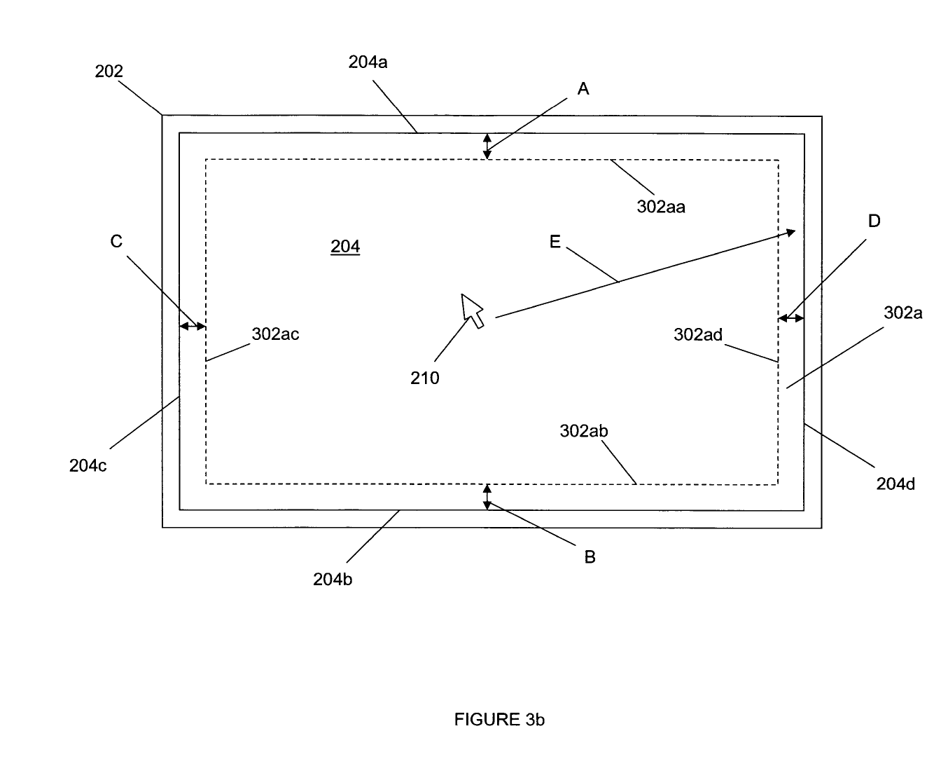

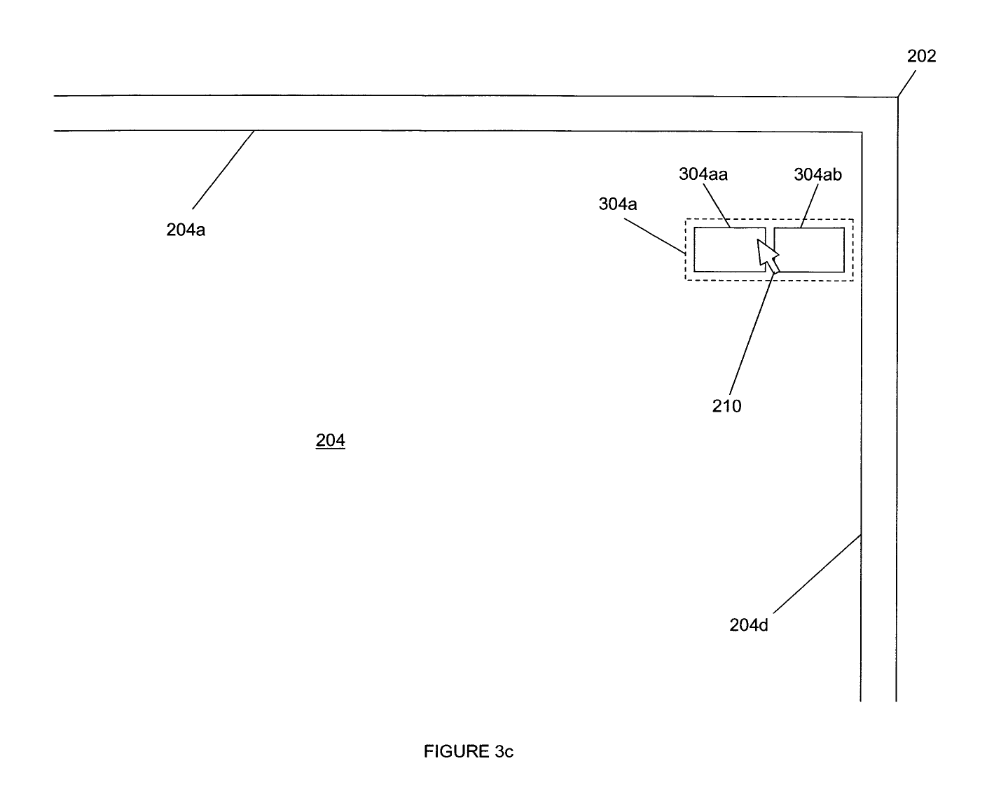

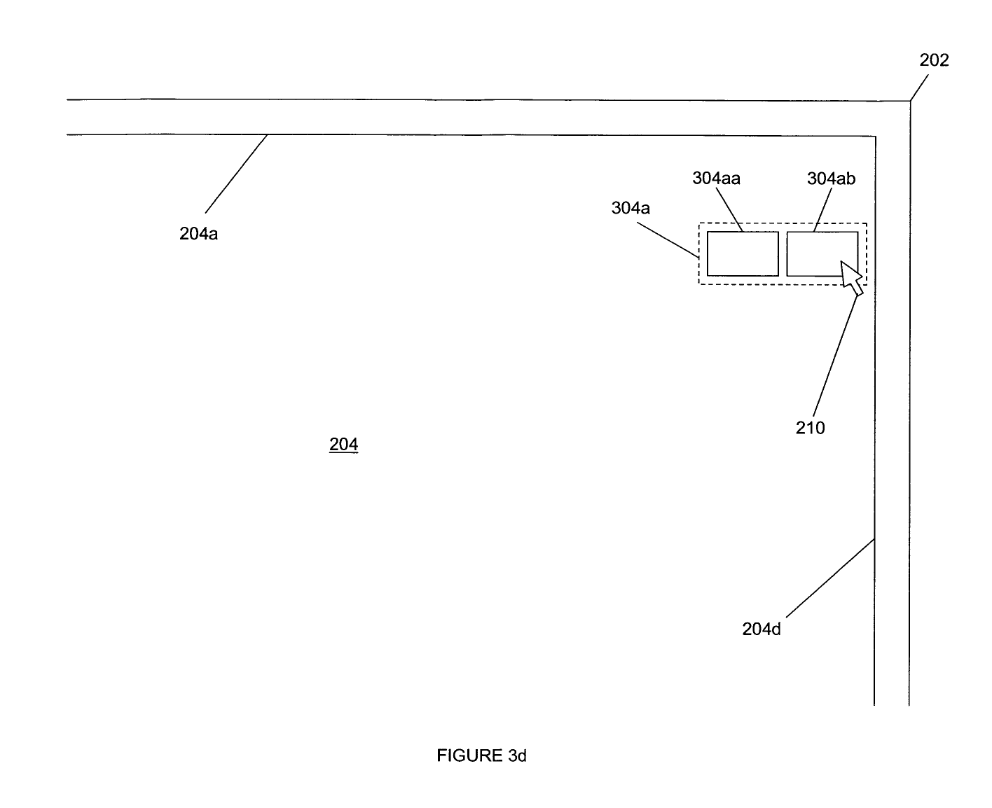

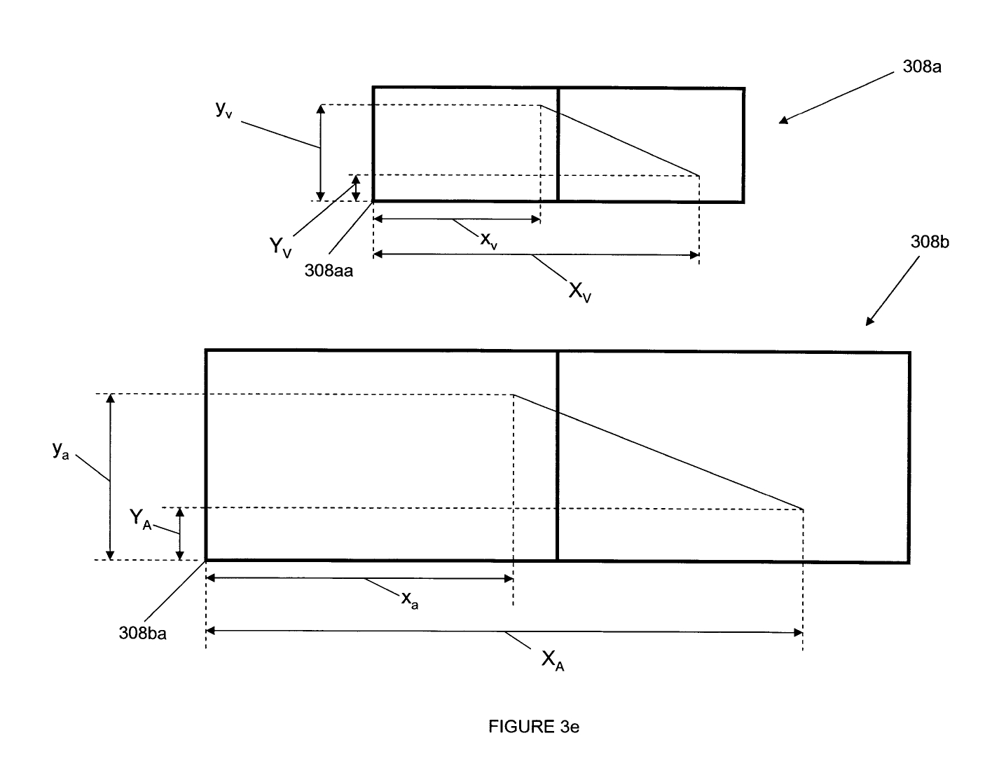

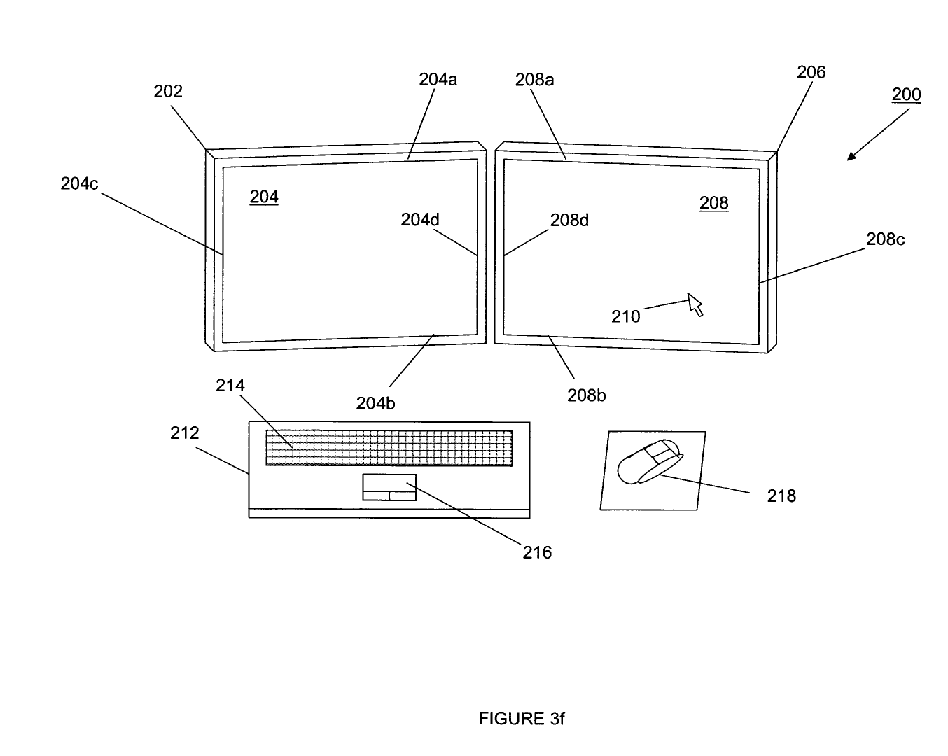

Referring now to FIGS. 1, 2, 3a, and 3b, a method 300 for display area navigation is illustrated. The method 300 begins at block 302 where an input device event is detected. In an embodiment, an input device event area 302a may be defined on the screen 204 of the first display device 202, illustrated in FIG. 3b. The input device event area 302a includes a top boundary 302aa that is offset from the top edge 204a of the screen 204 by a distance A, a bottom boundary 302ab located opposite the top boundary 302aa and offset from the bottom edge 204b of the screen 204 by a distance B, and a pair of side boundaries 302ac and 302ad that extend between the top boundary 302aa and the bottom boundary 302ab and are offset from the side edges 204c and 204d, respectively, of the screen 204 by a distance C and D, respectively. In an embodiment, the input device event area 302a may be an area located between the top boundary 302aa and the top edge 204a, the bottom boundary 302ab and the bottom edge 204b, the side boundary 302ac and the side edge 204c, and the side boundary 302ad and the side edge 204d. However, one of skill in the art will recognize that the definition of the input device event area 302a is not so limited, and may be defined only between one boundary and one edge (e.g., the area between the side boundary 302ad and the side edge 204d), as a centrally located area on the screen 204, or in any other manner that provides an input device event area that will allow the method 300 to function as desired by a user of the IHS 200, as is described below in further detail. While the input device event area 302a has been described as located on the screen 204 of the display 202, one of skill in the art will recognize that an input device event area may be defined on the screen 208 of the display 206, or on the screen of any other display, in substantially the same manner as is described above. In an embodiment, with the input device event area 302a defined as described above, the input pointer 210 may be moved in a direction E until the input pointer 210 is located at an input pointer location that is within the input device event area 302a. In an embodiment, the input pointer 210 may be moved, for example, by a user of the IHS 200 moving a finger on the track pad 216 of the first input device 212, by a user moving the second input device 218, and/or using a variety of other input pointer moving devices known in the art. In an embodiment, the IHS 100 will detect an input pointer location that is within the input device event area 302a as an input device event.

Referring now to FIGS. 2, 3a, 3b, and 3c, the method 300 then proceeds to block 304 where a display area navigation window is provided. In an embodiment, a display area configuration is the configuration of the screens 204 and 208 of the displays 202 and 206, respectively, that provide the display area. In an embodiment, the display area configuration may be determined when the IHS 200, including the displays 202 and 206, is set up by the user of the IHS 200. In an embodiment, the display area configuration may be determined upon the detection of the input device event at block 302 of the method 300. As illustrated in FIG. 2, the display area configuration for the IHS 200 includes the screens 204 and 208 located adjacent each other, as will be described and illustrated in further detail below. In an embodiment, upon detecting the input device event, the computer-readable medium in the IHS 100 uses the display area configuration to provide a display area navigation window 304a that includes a graphical representation of the display area configuration which, in the illustrated embodiment, includes a graphical representation of the screen 204 as element 304aa located adjacent a graphical representation of the screen 208 as element 304ab, as illustrated in FIG. 3c. In an embodiment, when the display area navigation window 304a is provided, the input pointer 210 is positioned at a location on display area navigation window 304a that corresponds to the position of the input pointer 210 on the display area. For example, as illustrated in FIG. 3c, the input pointer 210 is located in the upper right corner on the screen 204 of the display 202, adjacent the top edge 204a and the side edge 204d of the screen 204. When the display area navigation window 304a is provided, element 304aa in the display area navigation window 304a represents the screen 204 of the display 202, and the input pointer 210 is located in the upper right corner of element 304aa, at the same relative location on the element 304aa as the input pointer 210 is located on screen 204 of display 202.

Referring now to FIGS. 3a, 3c, and 3d, the method 300 then proceeds to block 306 where a display area navigation command is received. When the display area navigation window 304a is provided, the input pointer 210 is located at a first input pointer location on the display area. For example, as illustrated in FIG. 3c, the input pointer 210 is located at a first input pointer location that is in the upper right corner on the screen 204 of the display 202, adjacent the top edge 204a and the side edge 204b of the screen 204. That first input pointer location is also indicated by the position of the input pointer 210 on the display area navigation window 304a, with the input pointer 210 located in the upper right corner of element 304aa, at the same relative location on the element 304aa as the input pointer 210 is located on screen 204 of display 202. The user of the IHS 200 may use the first input device 212, the second input device 218, and/or a variety of other input devices known in the art to move the input pointer 210 on the display area navigation window 304a from the position illustrated in FIG. 3c (i.e., the upper right corner of element 304aa) to the position illustrated in FIG. 3d (i.e., the lower right corner of element 304ab.) The user of the IHS 200 may then provide a display area navigation command which includes, for example, pressing one of the plurality of keys 214 on the first input device 212, tapping a finger on the track pad 216 of the first input device 212, pressing a button on the second input device 218, and/or a variety of other input device commands known in the art.

Referring now to FIGS. 2, 3a, 3c, 3d, 3e, and 3f, the method 300 the proceeds to block 308 where the input pointer is relocated according to the display area navigation command. FIG. 3e illustrates an embodiment of a display area navigation window 308a that corresponds to the display area navigation window 304a provided in block 304a of the method 300, and a display area 308b that corresponds to the display area provided by the screens 204 and 208 of the displays 202 and 206, respectively. From a point 308aa on the display area navigation window 308a, the coordinates of the input pointer 210 on the display area navigation window 304a in the position illustrated in FIG. 3c may be represented by (xᵥ, yᵥ), and the coordinates of the input pointer 210 on the display area navigation window 304a in the position illustrated in FIG. 3d may be represented by (Xᵥ, Yᵥ). Furthermore, from a point 308b a on the display area 308b, the coordinates of the input pointer 210 in the first input pointer location, illustrated in FIG. 3c, may be represented by (xₐ, yₐ), and the coordinates of the input pointer 210 in a second input pointer location that will result from a relocation of the input pointer 210 according to the position of the input pointer 210 on the display area navigation window 304a in the position illustrated in FIG. 3d, described in further detail below, may be represented by (X_{A}, Y_{A}). The display area navigation window 308a and the display area 308b are dimensionally related by navigation constants that are determined, for example, by the desired size of the display area navigation window 304a on the display area. The relationships between the positions of the input pointer 210 on the display area navigation window 308a and the display area 308b may be given by the following equations:

xₐ=K₁*X

yₐ=K₂*Y

X_{A}=K₁*X_{V}

Y_{Z}=K₂*Y_{V}

In an embodiment, the IHS 100 may retrieve a navigation constant and use the navigation constant to determine a second input pointer location on the display area from the position of the input pointer 210 on the display area navigation window 304a shown in FIG. 3d. The input pointer 210 may then be relocated from the first input pointer location on the display area, illustrated in FIG. 3c, to the second input pointer location on the display are that is located in a lower right corner of the screen 208 on the display 206 adjacent the bottom edge 208b and the side edge 208c of the screen 208, illustrated in FIG. 3f. Thus, display area navigation is provided that allows an input pointer to quickly and accurately be navigated across a large display area.

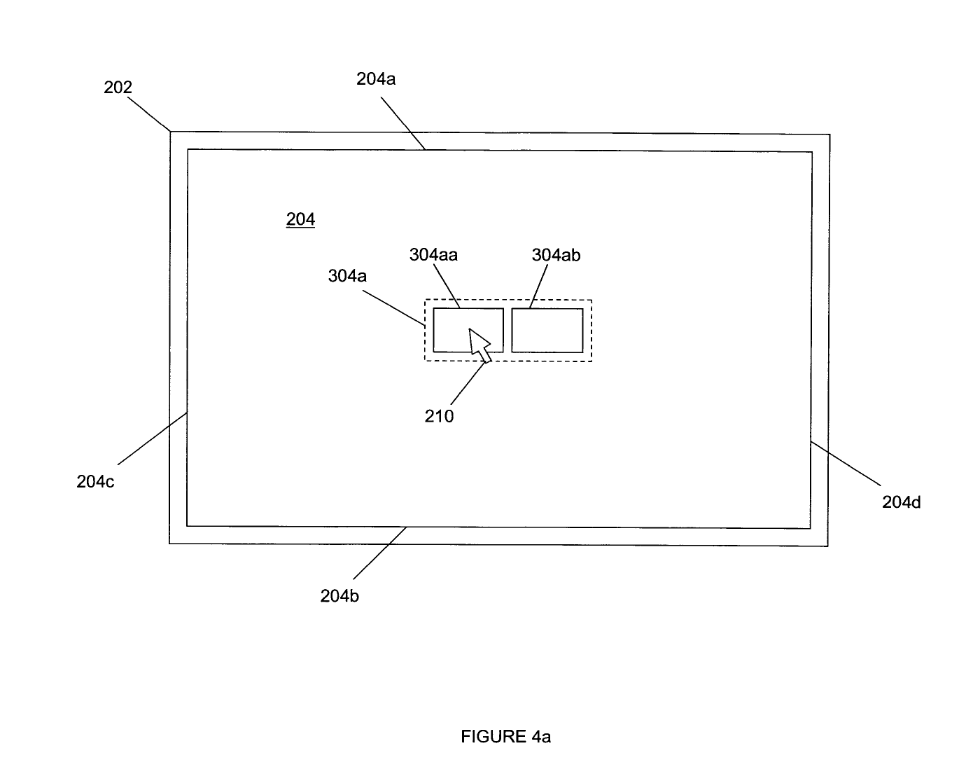

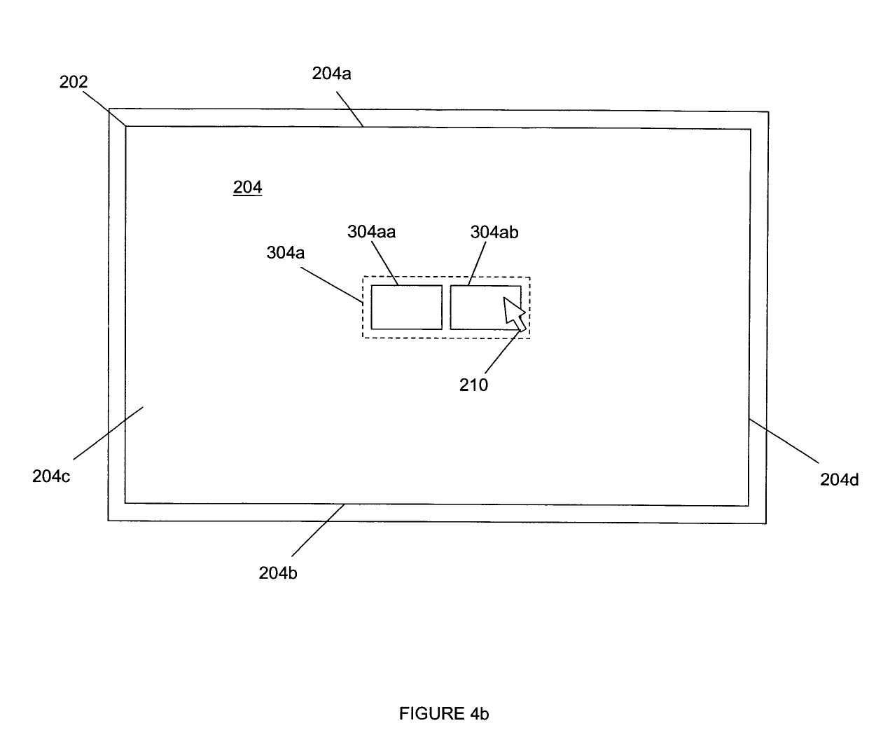

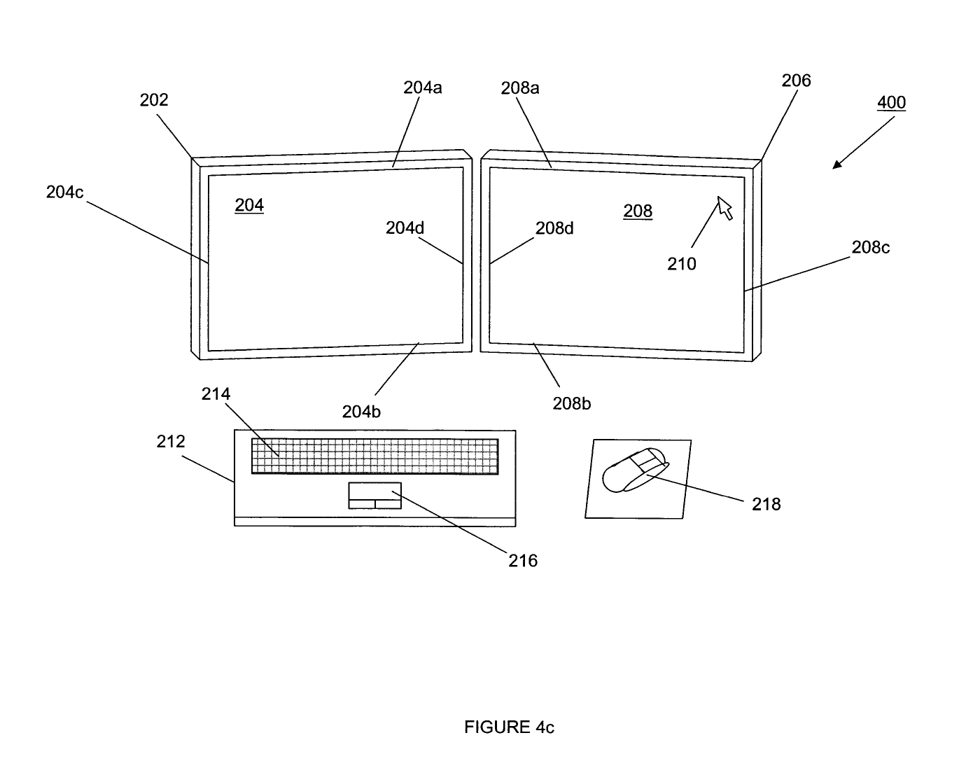

Referring now to FIGS. 2, 3a, 4a, 4b, and 4c, an IHS 400 is substantially similar in design and operation to the IHS 200 according to the method 300, described above with reference to FIGS. 2, 3a, 3b, 3c, 3d, 3e, and 3f, with the provision of a modified block 302 in the method 300. In an embodiment, the IHS 400 operated according to the method 300 illustrates an example of an alternative input event. At block 302, an input device event is detected. In the illustrated embodiment, the input device event may include a signal from an input device such as, for example, the first input device 212 and/or the second input device 218. In an embodiment, the signal from the input device may be a user pressing one of the plurality of keys 214 or a combination of the plurality of keys 214 on the first input device 212, tapping the track pad 216 on the first input device 212, using a distinct finger signal on the track pad 216 of the first input device 212, pressing a button on the second input device 218, moving the second input device 218 in a distinct pattern, and/or a variety of other input device events known in the art. Upon detection of the input device event, the display area navigation window 304a is provided at a location on the display area (e.g., the center of the screen 204 on the display 202 in the illustrated embodiment) with the input pointer 210 located in a position on element 304aa in the display area navigation window 304a that corresponds to the first input pointer location of the input pointer 210 on the display area shown in FIG. 4a, in a substantially similar manner to that described above for the IHS 200. The input pointer 210 may then be moved on the display area navigation window 304a from the position illustrated in FIG. 4a to the position illustrated in FIG. 4b and a display area navigation command may be received, in a substantially similar manner to that described above for the IHS 200. The input pointer 210 may then be relocated on the display area from the first input pointer location shown in FIG. 4a to a second input pointer location shown in FIG. 4c, in a substantially similar manner to that described above for the IHS 200.

Referring now to FIGS. 2, 3a, 5a, 5b, 5c, and 5d, an IHS 500 is substantially similar in design and operation to the IHS 200 according to the method 300, described above with reference to FIGS. 2, 3a, 3b, 3c, 3d, 3e, and 3f, with the provision of a third display 502, a fourth display 506, and a modified block 304 in the method 300. In an embodiment, the IHS 500 illustrates an example of an IHS having horizontally and vertically stacked displays that provide the display area. The third display 502 includes a third display screen 504 with a top edge 504a, a bottom edge 504b located opposite the top edge 504a, and a pair of opposing side edges 504c and 504d extending between the top edge 504a and the bottom edge 504b. In an embodiment, the third display 502 may be included in the display 110, described above with reference to FIG. 1. The fourth display 506 includes a fourth display screen 508 with a top edge 508a, a bottom edge 508b located opposite the top edge 508a, and a pair of opposing side edges 508c and 508d extending between the top edge 508a and the bottom edge 508b. In an embodiment, the fourth display 506 may be included in the display 110, described above with reference to FIG. 1. In an embodiment, the video controller 112 is operable to provide information on the display screens 204, 208, 504, and 508 as if the displays screens 204, 208, 504, and 508 were a single display screen using methods known in the art.

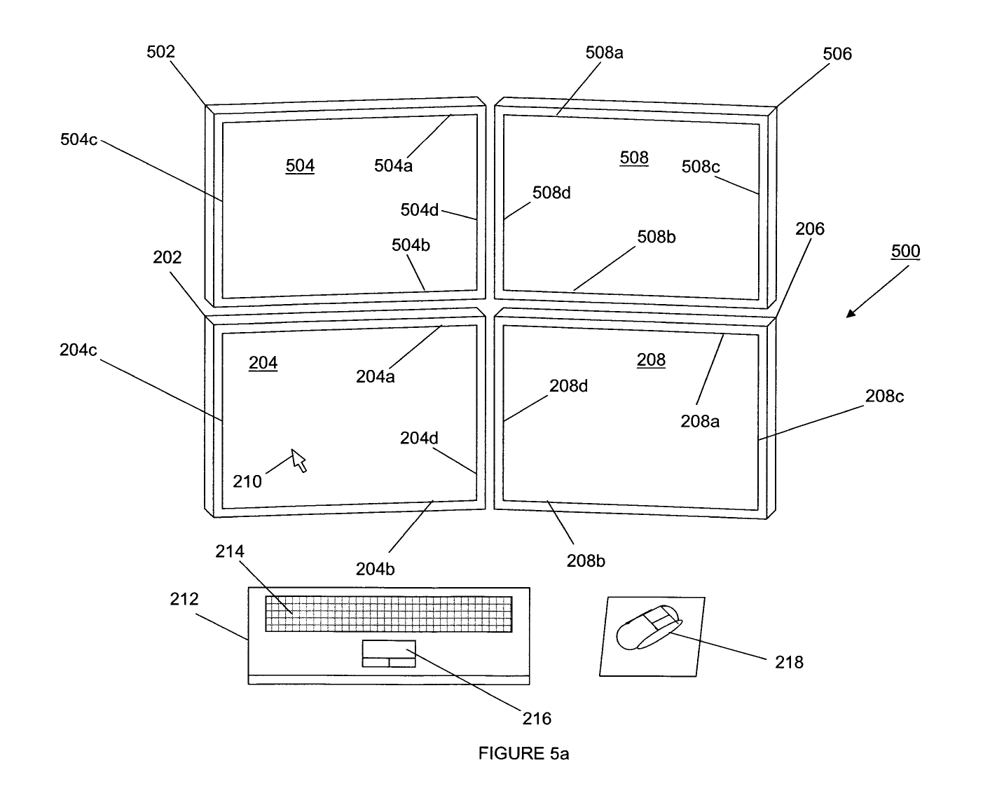

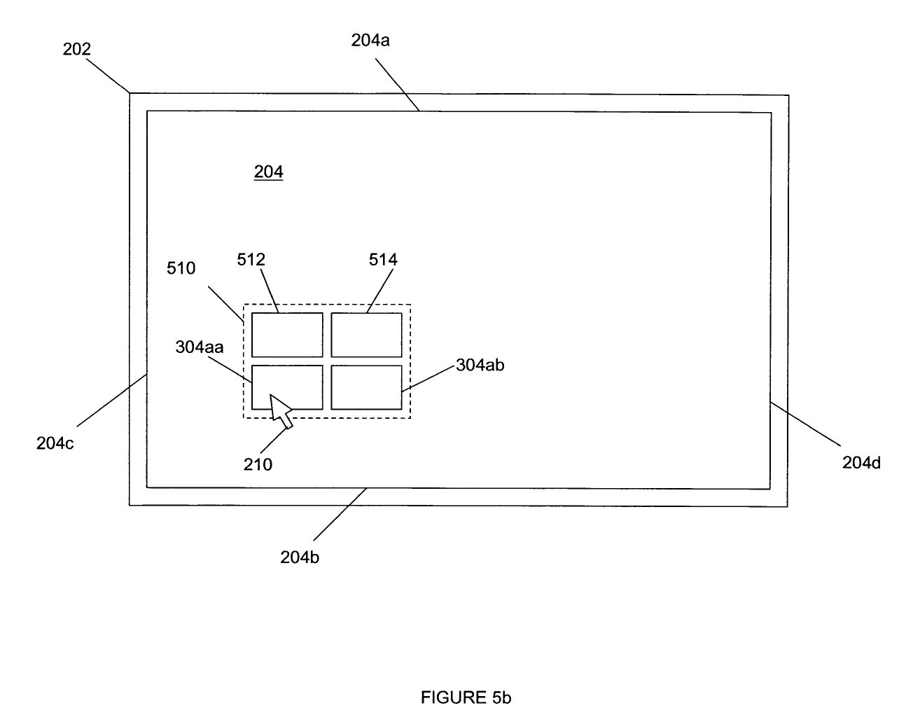

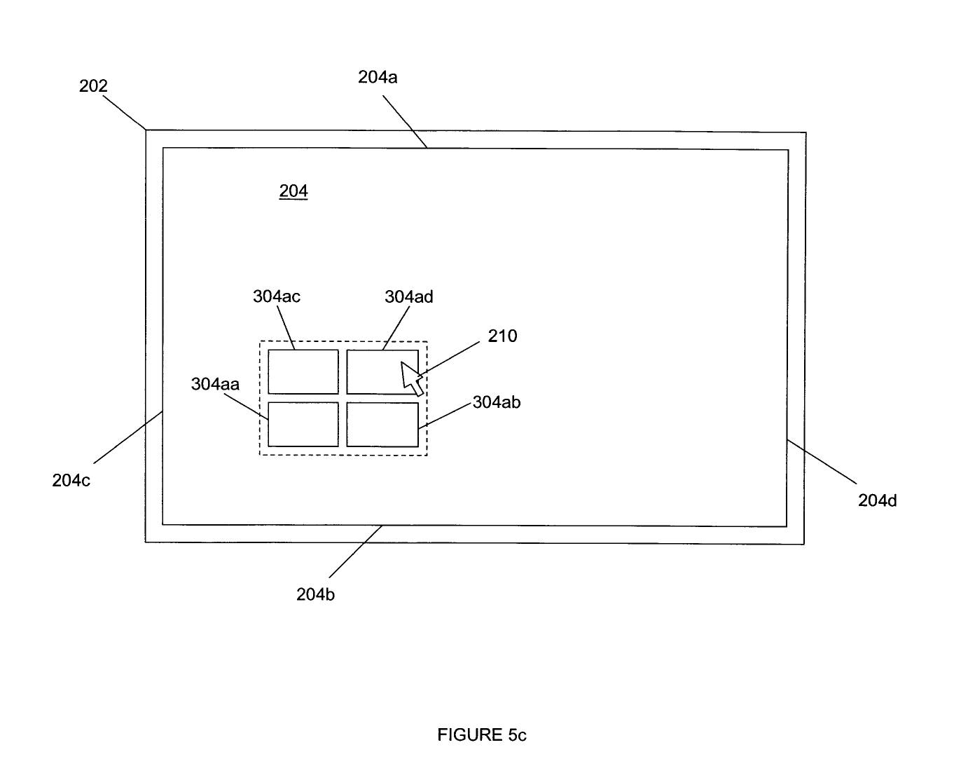

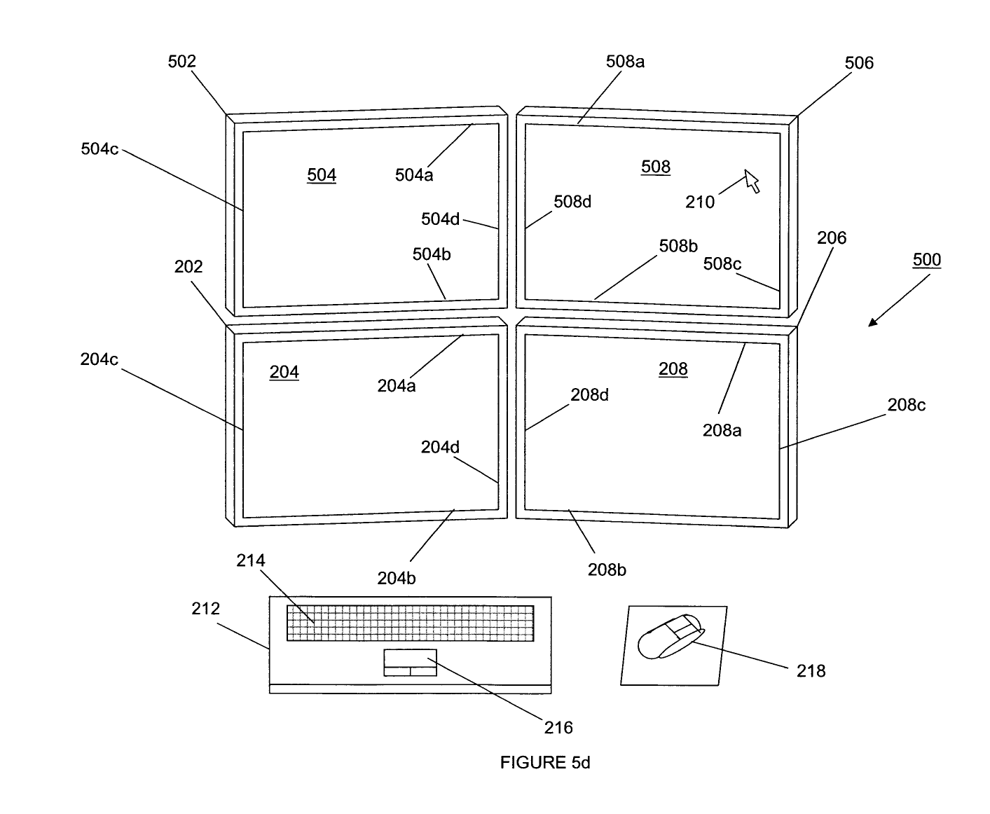

In an embodiment, a display area configuration is the configuration of the screens 204, 208, 504, and 508 of the displays 202, 206, 502, and 506, respectively, that provide the display area. In an embodiment, the display area configuration may be determined when the IHS 500, including the displays 202, 206, 502, and 506, is set up by the user of the IHS 500. In an embodiment, the display area configuration may be determined upon the detection of the input device event at block 302 of the method 300. As illustrated in FIG. 5a, the display area configuration for the IHS 500 includes the screens 204 and 208 located adjacent each other and the screens 504 and 508 located adjacent each other and above the screens 204 and 208, respectively, as will be described and illustrated in further detail below. In an embodiment, upon detecting the input device event, the IHS 100 uses the display area configuration to provide a display area navigation window 510 that includes a graphical representation of the display area configuration which, in the illustrated embodiment, includes a graphical representation of the screen 204 as element 304aa located adjacent a graphical representation of the screen 208 as element 304ab, a graphical representation of the screen 504 as element 512 located adjacent a graphical representation of the screen 508 as element 514, with elements 512 and 514 located above elements 304aa and 304ab, respectively, as illustrated in FIG. 5b. In an embodiment, when the display area navigation window 510 is provided, the input pointer 210 is positioned at a location on display area navigation window 510 that corresponds to the position of the input pointer 210 on the display area. For example, as illustrated in FIG. 5b, the input pointer 210 is located in the lower left corner on the screen 204 of the display 202, adjacent the bottom edge 204b and the side edge 204c of the screen 204. When the display area navigation window 510 is provided, element 304aa in the display area navigation window 304a represents the screen 204 of the display 202, and the input pointer 210 is located in the lower left corner of element 304aa, at the same relative location on the element 304aa as the input pointer 210 is located on screen 204 of display 202. The input pointer 210 may then be moved on the display area navigation window 510 from the position illustrated in FIG. 5b to the position illustrated in FIG. 5c and a display area navigation command may be received, in a substantially similar manner to that described above for the IHS 200. The input pointer 210 may then be relocated on the display area from the first input pointer location shown in FIG. 5a to a second input pointer location shown in FIG. 5d, in a substantially similar manner to that described above for the IHS 200.

Referring now to FIGS. 2, 3a, 6a, 6b, 6c, and 6d, an IHS 600 is substantially similar in design and operation to the IHS 200 according to the method 300, described above with reference to FIGS. 2, 3a, 3b, 3c, 3d, 3e, and 3f, with the provision of a third display 602 and a modified block 304 in the method 300. In an embodiment, the IHS 600 illustrates an example of an IHS having different sized and/or oriented displays that provide the display area. The third display 602 includes a third display screen 604 with a top edge 604a, a bottom edge 604b located opposite the top edge 604a, and a pair of opposing side edges 604c and 604d extending between the top edge 604a and the bottom edge 604b. In an embodiment, the third display 602 may be included in the display 110, described above with reference to FIG. 1. In an embodiment, the video controller 112 is operable to provide information on the display screens 204, 208, and 604 as if the displays screens 204, 208, and 604 were a single display screen using methods known in the art.

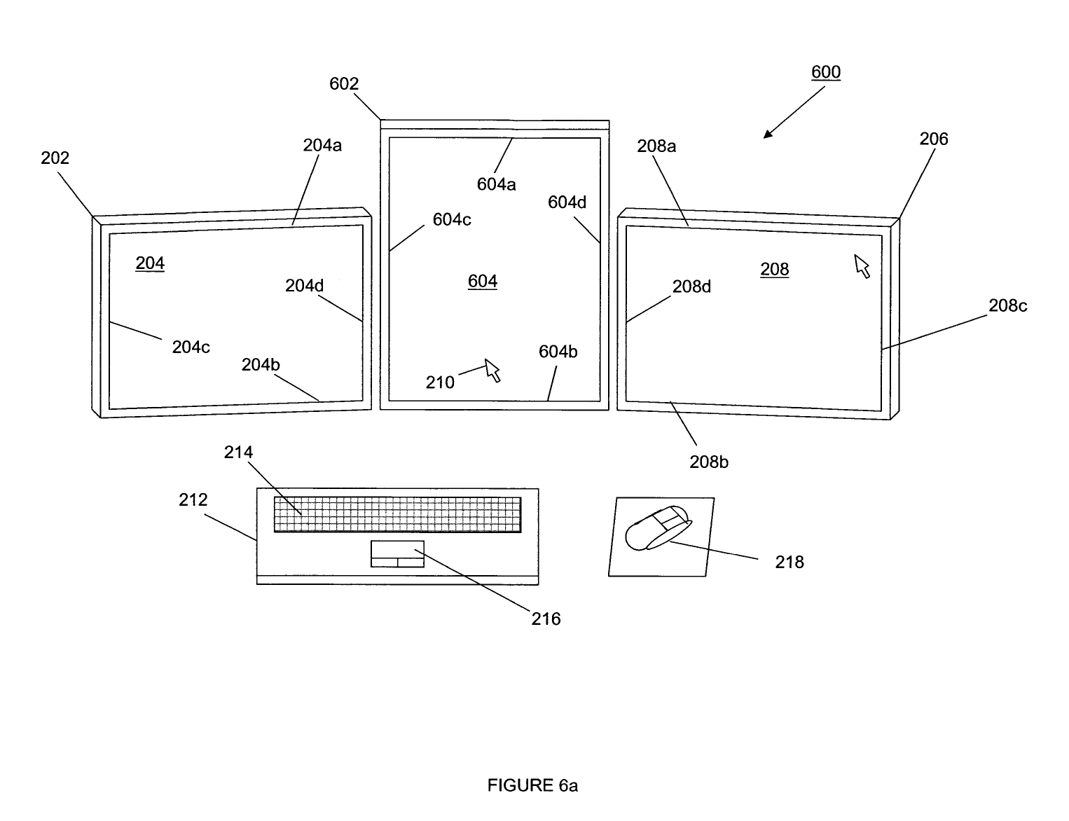

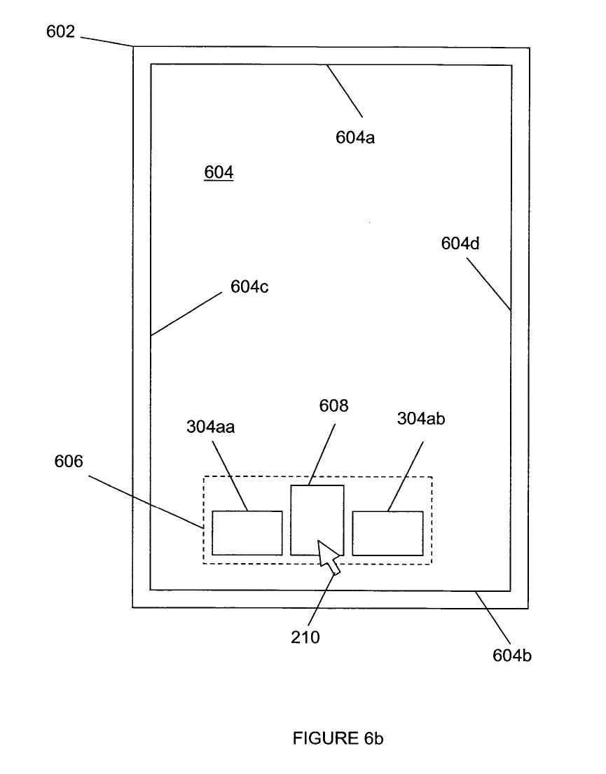

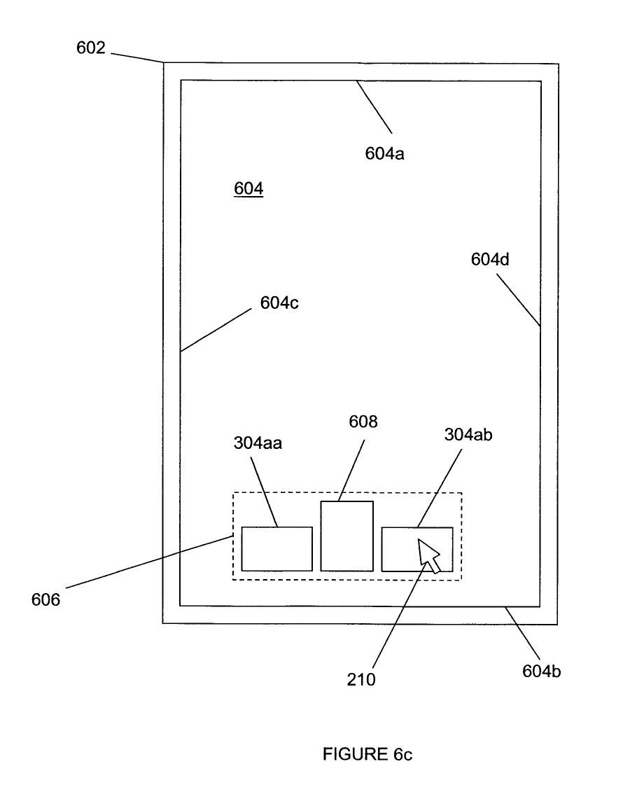

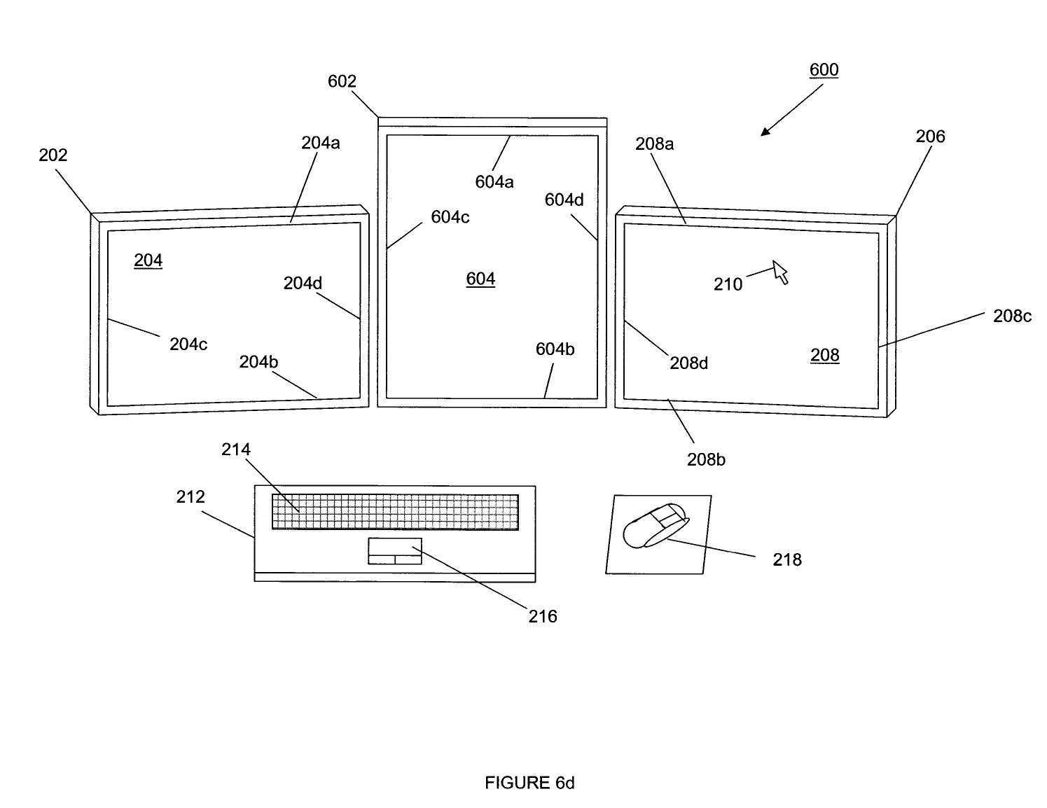

In an embodiment, a display area configuration is the configuration of the screens 204, 208, and 604 of the displays 202, 206, and 602, respectively, that provide the display area. In an embodiment, the display area configuration may be determined when the IHS 600, including the displays 202, 206, and 602, is set up by the user of the IHS 600. In an embodiment, the display area configuration may be determined upon the detection of the input device event at block 302 of the method 300. As illustrated in FIG. 6a, the display area configuration for the IHS 600 comprises the screens 204 and 208 located on either side of the screen 604, as will be described and illustrated in further detail below. In an embodiment, the display 602 may include a different size, orientation, and/or resolution than that of the displays 202 and 206. In an embodiment, upon detecting the input device event, the IHS 100 uses the display area configuration to provide a display area navigation window 606 that includes a graphical representation of the display area configuration which, in the illustrated embodiment, includes a graphical representation of the screen 204 as element 304aa and a graphical representation of the screen 208 as element 304ab located on either side of a graphical representation of the screen 604 as element 608, as illustrated in FIG. 6b. In an embodiment, when the display area navigation window 606 is provided, the input pointer 210 is positioned at a location on display area navigation window 606 that corresponds to the position of the input pointer 210 on the display area. For example, as illustrated in FIG. 6b, the input pointer 210 is centrally located in the lower portion on the screen 604 of the display 602, adjacent the bottom edge 604b. When the display area navigation window 606 is provided, element 608 in the display area navigation window 606 represents the screen 604 of the display 602, and the input pointer 210 is centrally located in the lower portion of element 608, at the same relative location on the element 608 as the input pointer 210 is located on screen 604 of display 602. The input pointer 210 may then be moved on the display area navigation window 606 from the position illustrated in FIG. 6b to the position illustrated in FIG. 6c and a display area navigation command may be received, in a substantially similar manner to that described above for the IHS 200. The input pointer 210 may then be relocated on the display area from the first input pointer location shown in FIG. 6a to a second input pointer location shown in FIG. 6d, in a substantially similar manner to that described above for the IHS 200.

Referring now to FIGS. 2, 3a, 7a, 7b, 7c, and 7d, an IHS 700 is substantially similar in design and operation to the IHS 200 according to the method 300, described above with reference to FIGS. 2, 3a, 3b, 3c, 3d, 3e, and 3f, with the provision of a single display 702 replacing the first display 202 and the second display 206, and a modified block 304 in the method 300. In an embodiment, the IHS 700 illustrates an example of an IHS having a single, large display that provides the display area. The single display 702 includes a single screen 704 with a top edge 704a, a bottom edge 704b located opposite the top edge 704a, and a pair of opposing side edges 704c and 704d extending between the top edge 704a and the bottom edge 704b. In an embodiment, the single display 702 may be included in the display 110, described above with reference to FIG. 1.

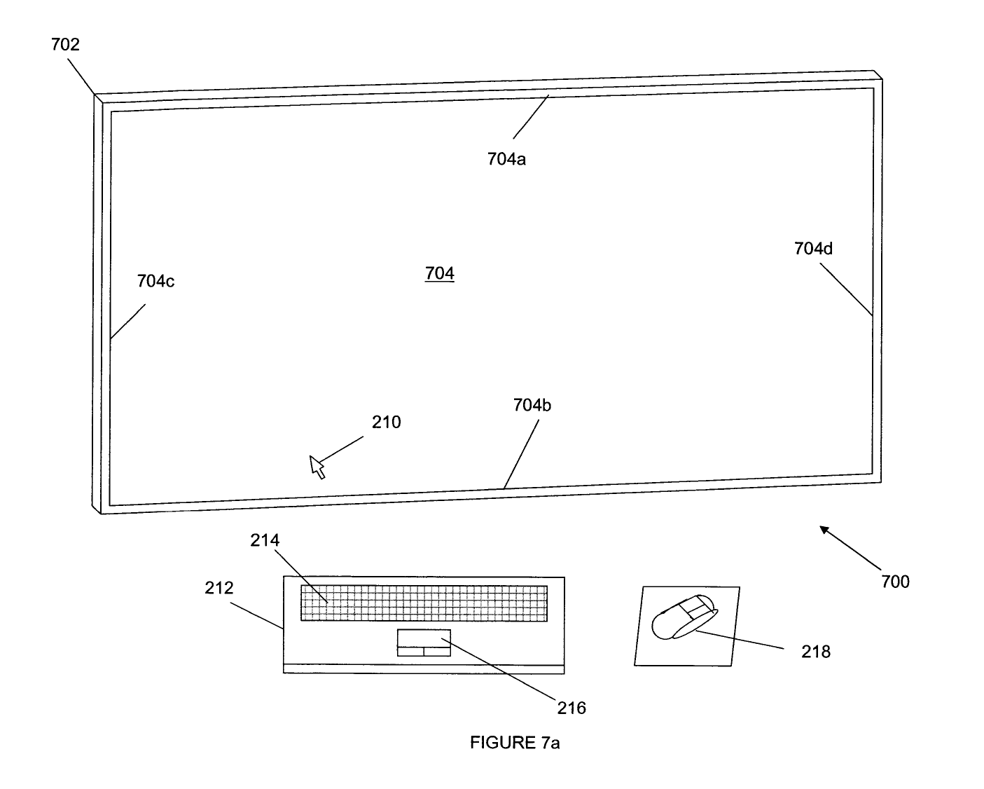

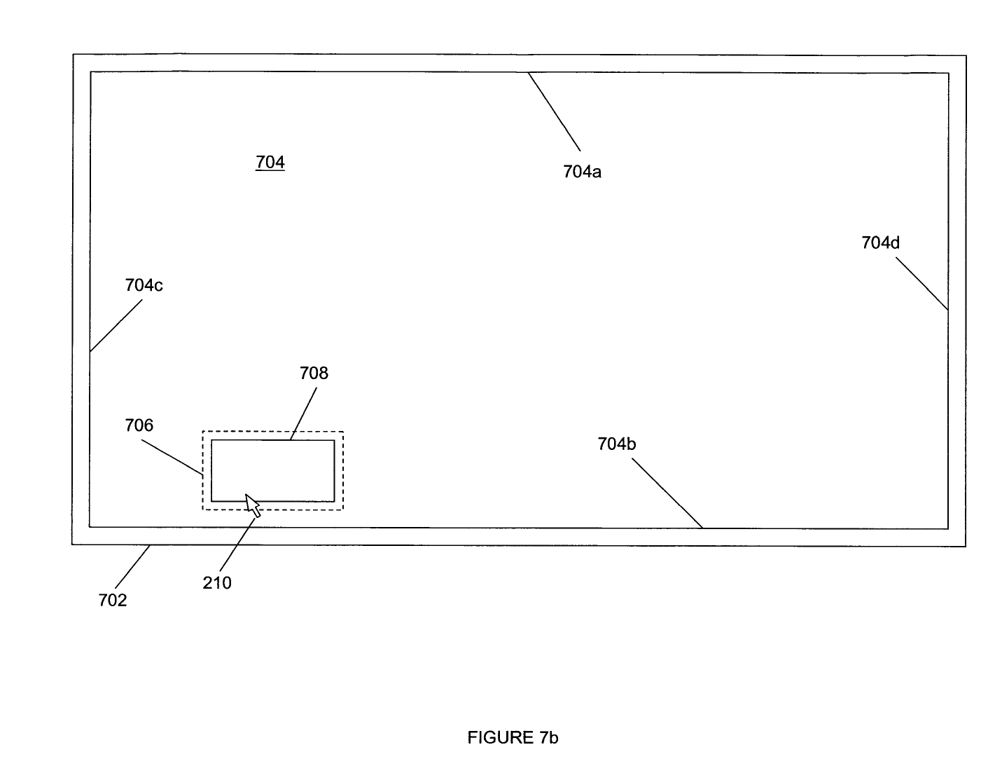

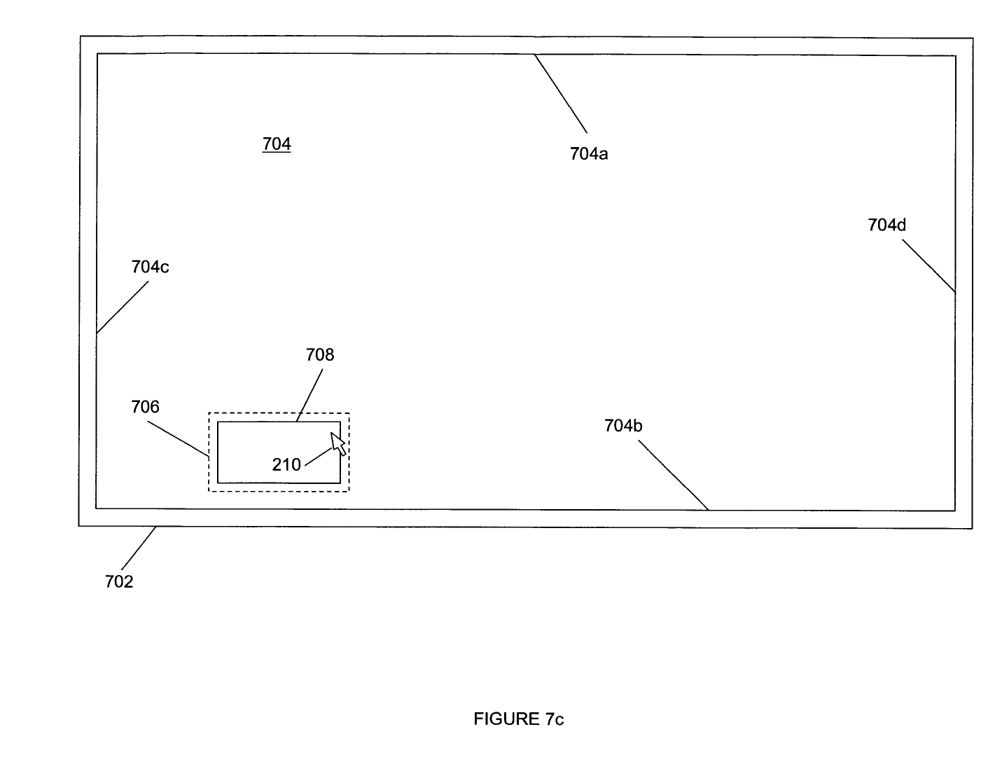

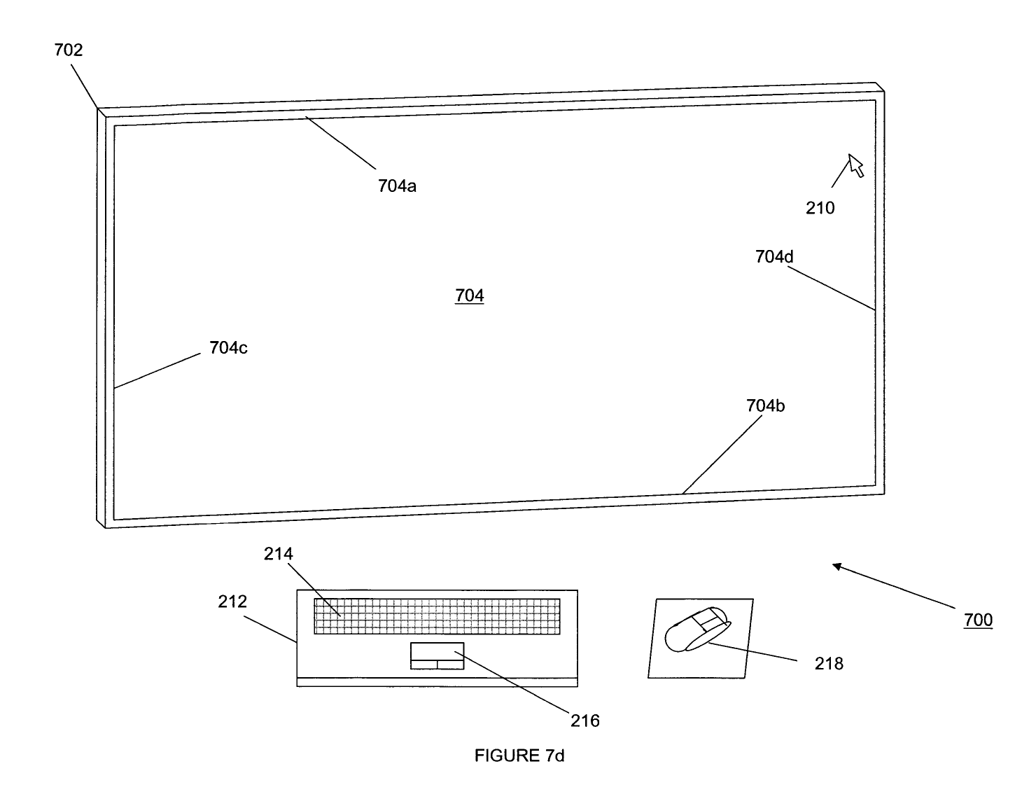

In an embodiment, a display area configuration is the configuration of the screen 704 of the single display 702 that provides the display area. In an embodiment, the display area configuration may be determined when the IHS 700, including the single display 702, is set up by the user of the IHS 700. In an embodiment, the display area configuration may be determined upon the detection of the input device event at block 302 of the method 300. As illustrated in FIG. 7a, the display area configuration for the IHS 700 comprises the screen 704, as will be described and illustrated in further detail below. In an embodiment, upon detecting the input device event, the IHS 100 uses the display area configuration to provide a display area navigation window 706 that includes a graphical representation of the display area configuration which, in the illustrated embodiment, includes a graphical representation of the screen 704 as element 708, as illustrated in FIG. 7b. In an embodiment, when the display area navigation window 706 is provided, the input pointer 210 is positioned at a location on display area navigation window 706 that corresponds to the position of the input pointer 210 on the display area. For example, as illustrated in FIG. 7b, the input pointer 210 is located in the lower left corner on the screen 704 of the display 702, adjacent the bottom edge 704b and the side edge 704c. When the display area navigation window 706 is provided, element 708 in the display area navigation window 706 represents the screen 704 of the display 702, and the input pointer 210 is located in the lower left corner of element 708, at the same relative location on the element 708 as the input pointer 210 is located on screen 704 of display 702. The input pointer 210 may then be moved on the display area navigation window 706 from the position illustrated in FIG. 7b to the position illustrated in FIG. 7c and a display area navigation command may be received, in a substantially similar manner to that described above for the IHS 200. The input pointer 210 may then be relocated on the display area from the first input pointer location shown in FIG. 7a to a second input pointer location shown in FIG. 7d, in a substantially similar manner to that described above for the IHS 200.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

1. A computer-readable medium comprising computer-readable instructions for display area navigation, the computer-readable instructions comprising instructions to:
detect an input device event;
provide a display area navigation window;
receive a display area navigation command; and
relocate an input pointer according to the display area navigation command.

2. The computer-readable medium of claim 1, wherein the computer-readable instructions to detect an input device event comprise computer-readable instructions to:
detect an input pointer location within a input device event area.

3. The computer-readable medium of claim 1, wherein the input device event area comprises an area located along at least one edge of a display area.

4. The computer-readable medium of claim 1, wherein the computer-readable instructions to detect an input device event comprise computer-readable instructions to:
detect a signal from an input device.

5. The computer-readable medium of claim 1, wherein the computer-readable instructions to provide a display area navigation window comprise computer-readable instructions to:
determine a display area configuration; and
provide the display area navigation window comprising a graphical representation of the display area configuration.

6. The computer-readable medium of claim 5, wherein the determining a display area configuration comprises determining a display area configuration for a single display.

7. The computer-readable medium of claim 5, wherein the determining a display area configuration comprises determining a display area configuration for a plurality of displays.

8. The computer-readable medium of claim 1, wherein the computer-readable instructions to relocate the input pointer according to the display area navigation command comprises computer-readable instructions to:
retrieve at least one navigation constant that reflects a relationship between a display area and the display area navigation window; and
use the navigation constant to relocate the input pointer from a first input pointer location on the display area to a second input pointer location on the display area.

9. An information handling system (IHS), comprising:
a processor;
an input device coupled to the processor;
a display area coupled to the processor; and
a computer-readable medium coupled to the processor, wherein the computer-readable medium comprises computer-readable instructions for display area navigation, the computer-readable instructions comprising instructions to:
detect an input device event;
provide a display area navigation window on the display area;
receive a display area navigation command; and
relocate an input pointer on the display area according to the display area navigation command.

10. The IHS of claim 9, wherein the computer-readable instructions to detect an input device event comprise computer-readable instructions to:
detect an input pointer location within a input device event area that is located on the display area.

11. The IHS of claim 10, wherein the input device event area comprises an area located along at least one edge of the display area.

12. The IHS of claim 9, wherein the computer-readable instructions to detect an input device event comprise computer-readable instructions to:
detect a signal from the input device.

13. The IHS of claim 9, wherein the computer-readable instructions to provide a display area navigation window on the display area comprise computer-readable instructions to:
determine a display area configuration for the display area; and
provide the display area navigation window comprising a graphical representation of the display area configuration.

14. The IHS of claim 9, wherein the display area is provided by a single display.

15. The IHS of claim 9, wherein the display area is provided by a plurality of displays.

16. The IHS of claim 9, wherein the computer-readable instructions to relocate the input pointer on the display area according to the display area navigation command comprises computer-readable instructions to:
retrieve at least one navigation constant that reflects a relationship between the display area and the display area navigation window; and
use the navigation constant to relocate the input pointer from a first input pointer location on the display area to a second input pointer location on the display area.

17. A method for display area navigation, comprising:
detecting an input device event;
providing a display area navigation window;
receiving a display area navigation command; and
relocating an input pointer according to the display area navigation command.

18. The method of claim 17, further comprising:
determining a display area configuration; and
providing the display area navigation window comprising a graphical representation of the display area configuration.

19. The method of claim 18, wherein the display area configuration comprises a multiple display configuration.

20. The method of claim 17, further comprising:
retrieving at least one navigation constant that reflects a relationship between a display area and the display area navigation window; and
using the navigation constant to relocate the input pointer from a first input pointer location on the display area to a second input pointer location on the display area.
